(19) United States
(12) Patent Application Publication
(10) Pub. No.: US 2019/0311361 A1
(43) Pub. Date: Oct. 10, 2019

(54) ADDING SECURITY TO A TRANSACTION BY VERIFYING LOCATIONS

(71) Applicant: CA, Inc., New York, NY (US)

(72) Inventors: Sharath L. KUMAR, Bangalore (IN); Sanjay Ramdas RAI, Bangalore (IN); Keerthidhara Mala DONGRE, Bengaluru (IN); Arun SHETTY, Bangalore (IN); Stephen PRASAD, Bengaluru (IN)

(73) Assignee: CA, Inc.

(21) Appl. No.: 15/948,274

(22) Filed: Apr. 9, 2018

(51) Int. Cl. G06Q 20/40; G06Q 20/32; G06F 17/30; G06Q 20/38

(52) U.S. Cl. CPC G06Q 20/401; G06Q 20/3224; G06Q 20/385; G06F 17/30241; G06F 17/30864

(57) ABSTRACT

A method includes receiving a transaction authorization request for a transaction between a user and a transaction system. The method also determines the location of the transaction system based and receiving the location of an account holder device associated with the account. The method also determines whether an increased authorization level is required for the transaction based on the location of the transaction system and the location of the account holder device. If the increased authorization level is required for the transaction, the method includes transmitting an increased authorization inquiry to the transaction system and receiving a response to the increased authorization inquiry. The increased authorization inquiry may be associated with a predetermined response. The method determines whether to authorize the transaction based on the response by the user and the predetermined response to the increased authorization inquiry.

### BACKGROUND

The disclosure relates generally to transaction payment systems, authorization networks, issuer networks, and more specifically to adding security to a transaction by verifying locations.

### BRIEF SUMMARY

According to one aspect of the present disclosure, a method includes receiving at an issuer system a transaction authorization request for a transaction between a user and a transaction system. And more specifically, the transaction authorization request may include transaction system data and account data associated with an account. The method also includes determining the location of the transaction system based on the transaction data received with the transaction authorization request and receiving the location of an account holder device associated with the account. The method also determines whether an increased authorization level is required for the transaction based on the location of the transaction system and the location of the account holder device. In response to determining the increased authorization level is required for the transaction, the method includes transmitting an increased authorization inquiry to the transaction system. The increased authorization inquiry may be associated with a predetermined response. In addition, the method includes receiving from the transaction system a response by the user to the increased authorization inquiry and determining at the issuer system whether to authorization the transaction based on the response by the user and the predetermined response to the increased authorization inquiry.

### BRIEF DESCRIPTION OF THE DRAWINGS

Aspects of the present disclosure are illustrated by way of example and are not limited by the accompanying figures with like references indicating like elements.

FIG. 1 illustrates a high-level block diagram of a system for adding security to a card transaction by verifying locations.

FIG. 2 illustrates a high-level diagram of a system for an account holder interacting with an issuer system via a mobile device.

FIG. 3 illustrates a high-level diagram of a system for a card user interacting with an issuer system via a transaction system.

FIG. 4 illustrates a high-level diagram of a system for a card user and an account holder interacting with an issuer system via a transaction system and a mobile device.

FIG. 5 illustrates communications between a mobile device and an issuer system via an application programming interface.

FIG. 6 illustrates a flowchart for a method for adding security to a card transaction by verifying user locations.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The methods and systems within the scope of the present disclosure may be described with respect to payment systems, transaction systems, payment networks, authorization networks, credit or debit card transactions, internet transactions, and payment processing. In addition, the embodiments described herein may be described with respect to physical payment cards, but the scope of the present disclosure extends to online internet transactions as well, as is described. One of skill in the art would recognize that the scope of the present disclosure is not limited to the exemplary fields of use expressly described herein, and that the systems and methods have application beyond the specifically described fields or applications.

While the embodiments described herein may be useful and applied in many different contexts, they present a unique solution to card skimming by fraudsters. Card skimming is widely prevalent and results in many fraudulent transactions. Card skimming is a type of bank card theft that uses devices to capture and store the account and card details stored on the magnetic stripe of a payment card and, in more sophisticated operations, may also include a camera or other sensor to capture personal identification numbers associated with debit cards, for example. While each card may vary, the magnetic stripe on a payment card typically stores the card number, expiration date, and the account holder's full name. Once a fraudster obtains this information, by downloading it from the skimmer devices, they may use the information to encode a fraudulent card with the account holder information, thereby creating an unauthorized duplicate card. Or, the fraudster may use the account information to initiate transactions remotely, via telephone or internet networks where a physical card need not be present to process the transaction. While a person who loses their payment card may simply report it to the banking institution as lost or stolen, card skimming results in the misappropriation of account information without the account holder even knowing it.

The problem is more acute in the local fraudster situation, where the fraudster is using the unauthorized duplicate card or account in the same city or state as the account holder. While some banks may flag a transaction as potentially fraudulent that occurs across the country or on the other side of the world, without prior notice from the account holder, most banking systems would not flag transactions by the fraudster which were initiated locally or in areas where the true account holder typically transacts within a certain vicinity of the account holder's home, such as within the same city, state, or even region.

Thus, card skimming presents a problem that is both localized and worldwide. To address the issue with card skimming, the methods and systems herein leverage the geographical dispersion between unauthorized holders of card or account information and the true account holder to provide a solution to this issue to prevent the authorization of fraudulent transactions by a seemingly valid transaction card or account information by verifying locations. More specifically, the embodiments described herein may go beyond detecting a potentially fraudulent transaction and may alter payment networks and transaction processing schemes by using parallel channels to verify the locations of both the user who initiated the transaction and the account holder to determine if increased authorization is needed before the transaction is authorized. For example, if the system determines that the card user and the account holder are geographically far from each other, the systems and methods described herein may alter the routine transaction processing by requiring increased authorization, and the transaction may only be authorized after an increased authorization protocol is satisfied.

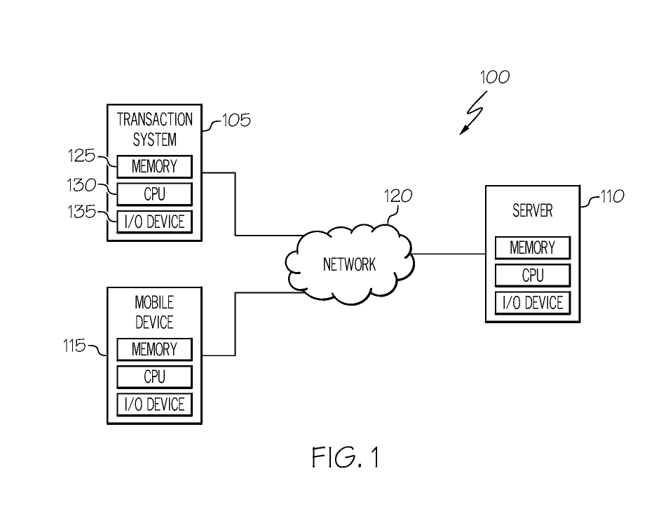

Referring now to FIG. 1, a system 100 for adding security to a cad transaction by verifying locations is illustrated. The system may include a transaction system 105, issuer system 110, and mobile device 115. Each of transaction system 105, issuer system 110, and mobile device 115 may be computing devices or may include memory 125, a central processing unit (CPU) 130, and one or more interface components for input/output operations. As illustrated in FIG. 1, transaction system 105, issuer system 110, and device 115 may be interconnected and communicate over a network 120. Network 120 may include but not be limited to the internet, public switched telephone network, fiber optic networks, cable networks, digital subscriber line network, or other wired or wireless networks or communication networks.

In some embodiments, transaction system may include but not be limited to, for example, a point-of-sale (POS) system, an automated teller machine (ATM), a card reader or other magnetic stripe reader, a chip card reader, a near-field communication (NFC) reader or other contactless payment readers, a merchant web server or web payment center or server or gateway. These may be, for example, different embodiments of interface components 135. In general, the transaction system 105 refers to the origin system related to a transaction or, in other words, where a user or cardholder initiates a transaction by swiping his or her card or entering payment information. For example, if a user swipes their card at a merchant store, the merchant's POS system may be part of the transaction system 105. In another embodiment, transaction system 105 may be a payment server associated with a merchant website, where a user enters their card information and account holder information through a webpage or portal.

Issuer system 110 may include but not be limited to an acquirer system or network, a credit card system or network, or ultimately the issuing bank system. As one of skill in the art may appreciate, the issuing bank responds to authorization requests by either authorizing or denying authorization of the transaction. Thus, a cardholder may initiate a transaction authorization request by paying or swiping his or her card at a merchant's transaction system, whereupon the merchant system may send the account and card details to an acquirer, whereupon the acquirer may forward the account and card details to the appropriate credit card network, where the credit card network then requests payment authorization from the issuing bank associated with the account. Therefore, in some embodiments, the issuer bank may receive a transaction authorization request from the transaction system notwithstanding the several possible intermediaries, because the transaction system is the point of origin of the transaction. In such an embodiment, if funds for the transaction are available in the account holder's account, the issuing bank system may send an approval code to the transaction system via the same channel. The merchant or transaction system may then issue a receipt to the customer to complete the sale.

The device 115 may include smartphones, desktop computers, laptop computers, tablets, other handheld devices or mobile devices, or the like. Thus, in some embodiments, the device 115 may be a device with communication capability that one of ordinary skill in the art would appreciate may be expected to be with or spatially near its owner. In some embodiments, the device 115 may be a mobile device such as a smartphone and may comprise one or more applications. For example, the application may be a banking application that is associated with or provided by an issuing bank. In other embodiments, the application may comprise a daemon that runs in the background and processes and answers requests for services from, for example, the issuing bank system 110. In some embodiments, such as where the device 115 comprises an application associated with the issuer system 110, such as a banking or payment application associated with the issuer system 110, the application on the device 115 and the issuer system 110 may communicate. In some embodiments, they may communicate via known networking protocols or via an application program interface.

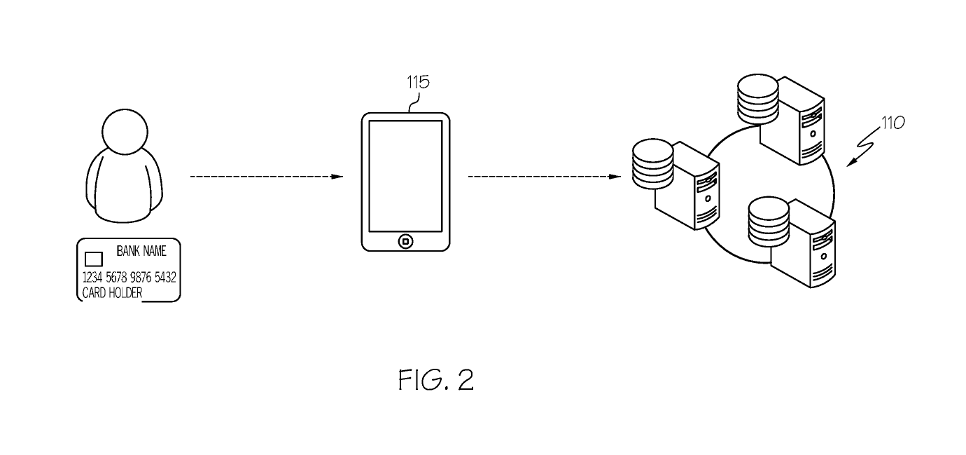

Referring to FIG. 2, a system for an account holder interacting with the issuer system 110 via a mobile device 115 is illustrated. For example, the account holder may register or associate his or her card with the application on the mobile device 115, and such association may be conveyed to the issuer server 110. As a result, the issuer server is able to associate the payment card with a mobile device associated with the account holder. The issuer server 110 may thus maintain a database of account information associated with an account, including a verified account holder device associated with the verified account holder, such as device 115. Using device 115, the account holder may be able to monitor his or her account using, for example, a graphical user interface to send and receive API calls to and from the issuer server 110.

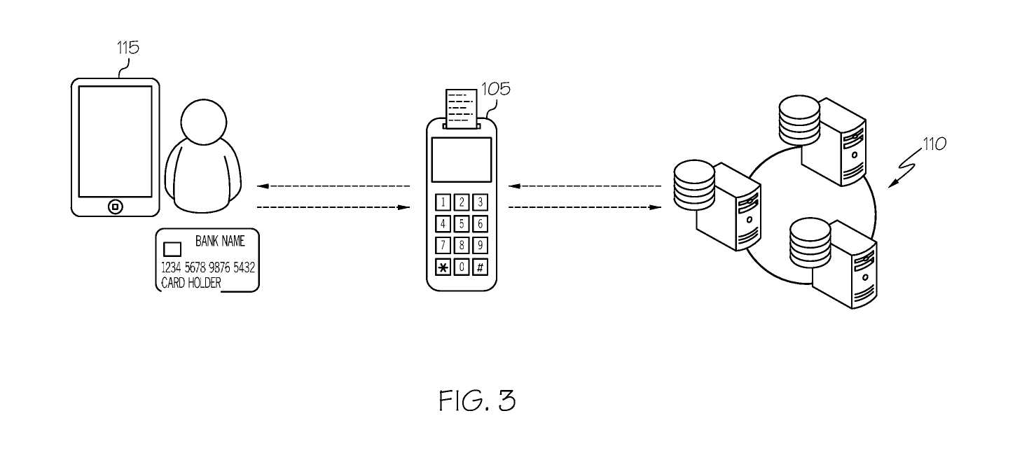

Referring now to FIG. 3, a system for a cardholder or user interacting with an issuer system via a transaction system is depicted. More specifically, a user may interact with the transaction system 105, and the transaction system 105 may communicate with the issuer system 110, and the issuer system 110 may respond back to the transaction system 105, which may then communicate and interact with the user. In some embodiments, a user may swipe a card at transaction system 105, thereby providing account details to the transaction system 105. The transaction system 105 may then convey those details through the payment network which are ultimately provided in the form of a transaction authorization request for the transaction at the issuer system 110. Authorization messages and requests may utilize ISO 8583 or proprietary or other formats where applicable. For most embodiments, the standard ISO 8583 fields or data elements are sufficient for the systems and methods disclosed herein. Thus, messages transmitted between the transaction system 105 and the issuer system 110 may be ISO 8583 messages and may include the standard fields specified therein, including information associated with the transaction system, such as an identifier or location, and data associated with the account, such as the account or card number and the expiration date. The issuer system 110 may then approve or deny authorization of the transaction and may communicate back to the transaction system 105 and the user. Such response back from the issuer system 110 may include an authorization approved message, an authorization denied message, or may include an increased authorization request.

In some embodiments, an increased authorization request may comprise a request or instruction from the issuer system 110 to the transaction system 105 to prompt the user or cardholder for additional information needed before authorizing a transaction. For example, the issuer system 110 may send a message to transaction system 105 causing transaction system 105 to prompt the user or cardholder to enter a password. In some embodiments, the password could be a personal identification number (PIN) associated with the account data for the transaction. In some embodiments, the password may be a unique and/or predetermined password associated with the account other than a PIN number, since such numbers may be compromised due to card skimming. In addition, the request for increased authorization could solicit responses to a set of security questions associated with the account. In other embodiments, the increased authorization request may solicit an input by the user comprising a NFC communication from a mobile device, such as a one-time password generated by the application associated with the issuer system running on the device or a device ID for a device associated with the account such as, for example, a registered device as described above with reference to FIG. 2.

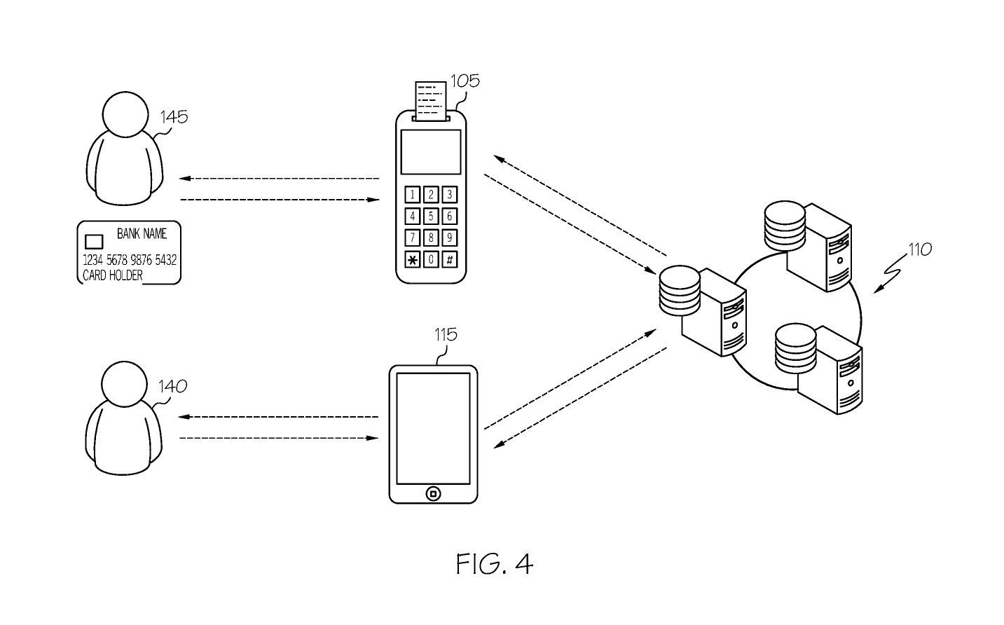

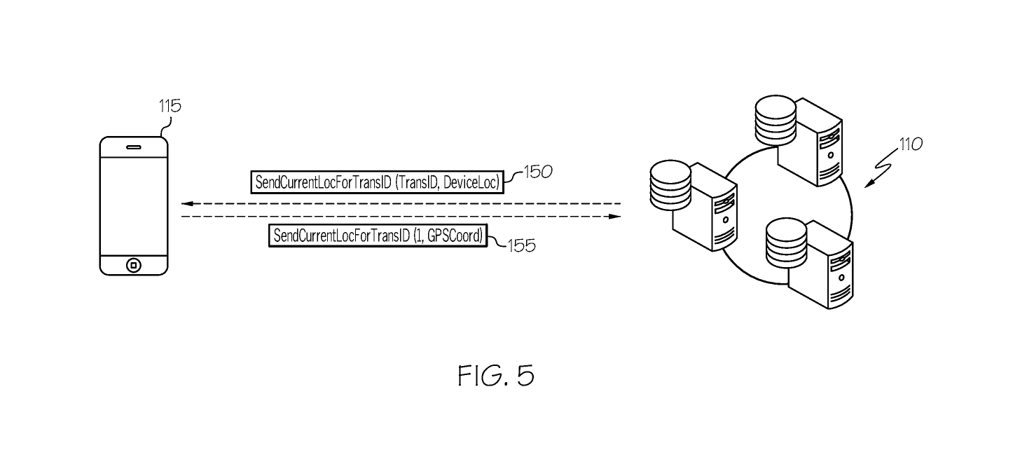

Referring to FIG. 4, a system for a card user and an account holder interacting with an issuer system via a transaction system and a mobile device is illustrated. More specifically, the systems and methods described herein may be implemented using a system configuration such as that illustrated in FIG. 4, wherein an account holder 140 is able engage in bi-directional communication with the issuer system 110 via device 115, and a cardholder or user 145 is able to engage in bi-directional communication with the issuer system 110 via transaction system 105. The bi-directional communications between the transaction system 105 and the issuer server 110 may comprise those described above with reference to FIG. 3. Similarly, the bi-directional communications between the device 115 and the issuer system 110 may comprise those described above with reference to FIG. 2. In addition, the bi-directional communications between the device 115 and the issuer system 110 may comprise those described below with reference to FIG. 5.

Referring to FIG. 5, the communications between mobile device 115 and issuer system 110 may comprise API calls between the two devices. For example, issuer system may send a device request 150 via an API call, to which device 115 may send a response 155 using the appropriate API call response. In some embodiments, the request 150 may comprise a push notification to the device 115 with a transaction ID as payload, to which the response 155 to the issuer system 110 may comprise an API call with the transaction ID as payload. Thus, the issuer system 110 and the device 115 may be able to communicate regarding a specific transaction by including or referencing a transaction ID in the payload of each message. Various types of information can be exchanged between the device 115 and the issuer system 110. For example, the issuer system 110 may request the device 115 respond with the location of the device, obtained from GPS or other navigation technology associated with device 115.

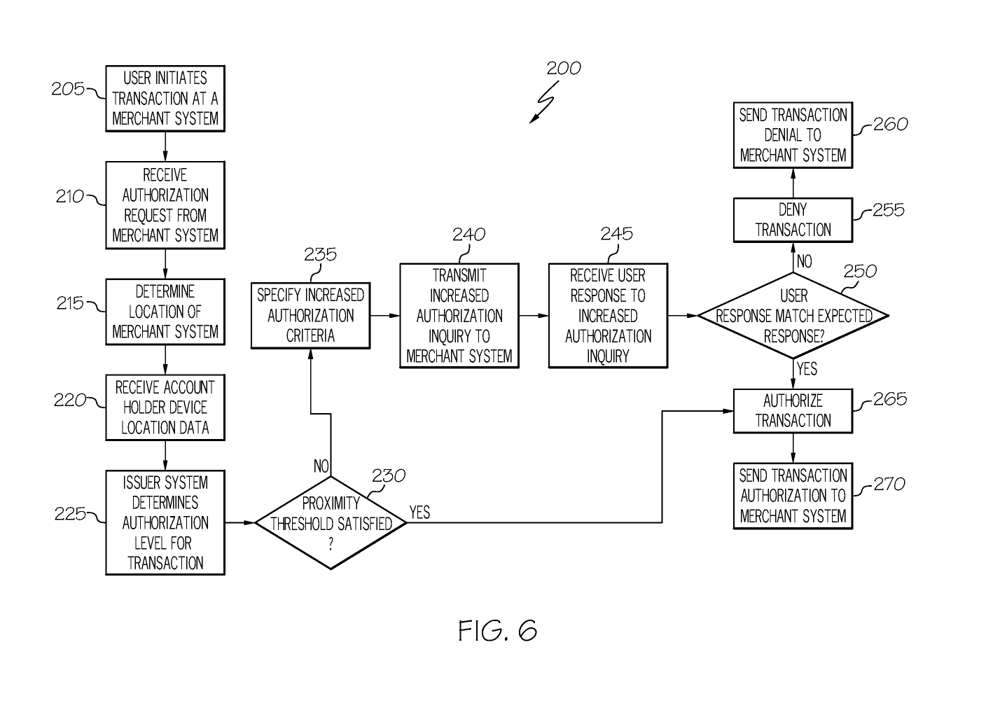

Referring now to FIG. 6, a method for adding security to a card transaction by verifying user locations is described. At step 205, a user may initiate a transaction at a transaction system such as a merchant system. The merchant system may then relay an authorization request message through the payment networks, such as that described above, to the issuer system 110. The issuer system 110 may then receive the authorization request from the merchant system 105 at step 210. Upon receiving the authorization request from the transaction system 105, the issuer system may determine the location of the transaction system at step 215.

Embodiments may determine the location of the merchant system at step 215 in many ways. For example, some embodiments the issuer system may determine the location of the transaction system based on data associated with the transaction system included in the received authorization request. In such embodiments, the issuer system may identify transaction system identification information, such as a merchant ID or merchant address from the transaction authorization request message. Then, a location database may be queried using the merchant identification information to lookup the merchant's location. For example, the issuer or a related entity may maintain a merchant or transaction system location database whereupon the location of each transaction system can be reasonably ascertained from the merchant's basic identification information such as the merchant's identification number, name, or other such information. In other embodiments, the location information associated with the transaction system may comprise a logical network address such as an IP address, for example, if the transaction system is a gateway or web payment portal.

At step 220, the issuer system 110 may receive account holder device location data. The account holder device location data may be geographical location data associated with the account holder device. In some embodiments, in response to receiving a request for authorization associated with an account, the issuer system 110 may identify the account holder device associated with the account, which may have been registered with the issuer system 110 through an application on the device 115 for example. Upon identifying the account holder device associated with the account, the issuer system may send a notification such as a push notification to the device 115, as described above, soliciting the device 115 to respond with the geographical location data. Such geographical location data may include longitudinal, latitudinal, and/or altitudinal data associated with the device 115.

At step 225, the issuer system 110 may determine an authorization level for the transaction. In some embodiments, the system may determine whether an increased authorization level is appropriate for the transaction based on the transaction system location and the account holder device location. In such systems, the issuer system 110 may determine or cause to be determined at step 230 whether a proximity threshold is satisfied based on a comparison of the transaction system location to the account holder device location. Thus, the system may determine whether additional or increased authorization parameters are needed before authorizing the transaction based on a comparison of the location of the account holder device, which is presumed to accompany the account holder, with the transaction system location, which is where the account holder's card is being used. The proximity threshold may be, for example, a specified radial threshold comprising a maximum distance the transaction system and the account holder device may be from each other. In other embodiments, the proximity threshold may be more abstract, for example, determining whether the transaction system and the account holder device are in the same city, state, country. In other embodiments, the proximity threshold may refer to a specific altitudinal delta, such that the system could detect if a user's card was being used in the street-level bakery of a high-rise office building while the account holder's device was located twelve stories above in their office on the top floor. Thus, the location data may be coordinates associated with longitude, latitude, altitude, or it may be basic address information such as street, city, state, zip code, country, for example.

In addition, the proximity threshold may be specified in terms of a maximum distance apart or a minimum distance together, meaning that the threshold can be satisfied either when the account holder device and the transaction system are far enough apart to trigger increased authorization or close enough together to bypass increased authorization, depending on the configuration of the embodiment. Furthermore, the proximity threshold may be configurable, and may have a default setting. Thus, account holders can control the level of security regarding location verification they prefer to be associated with their account or particular ones of their accounts.

In an embodiment wherein the proximity threshold refers to minimum distance together, for example, if the account holder device is not within the specified proximity of the transaction system, the threshold will not be satisfied. In response to determining the threshold is satisfied, meaning that the account holder device and the transaction device are located sufficiently proximate to one another, the system may authorize the transaction at step 265 and send a transaction authorization message to the merchant system at step 270, thereby completing the transaction. However, in response to determining that the threshold is not satisfied, the system may determine the increased authorization level is required for the transaction because the account holder device and the transaction device are not sufficiently proximate enough to one another to ensure that the account holder is the user who initiated the transaction at the transaction device. At step 235, if the increased authorization level is specified for the transaction the issuer system may select an increased authorization criterion from several increased authorization criteria. The increased authorization criteria may include, but not be limited to, a specified password, a one-time password associated with the account holder device, security questions associated with the account, for example. The system may select one or more authorization criteria for the transaction in response to determining that increased authorization is required. The criterion or criteria may be chosen randomly, such that each determination of increased authorization may be associated with a different authorization criterion or set of criteria. Each increased authorization criteria may be associated with a predetermined response. For example, the account holder may define the set of increased authorization criteria and the corresponding responses by selecting a password or security questions and providing answers. Thus, each increased authorization criterion may be associated with a corresponding response.

In some embodiments, the account holder's device and the issuer system may select the increased authorization criteria to be a one-time password shared between the issuer system and the account holder device, or to be another identifier associated with the account holder device such as a device identifier or token stored on the device, which may be communicated to the transaction system via a NFC reader. In the embodiment where the increased authorization criterion is a one-time password shared between the issuer system and the account holder device, the issuer system may determine the one-time password and transmit it to the account holder device.

In other embodiments, such as where the transaction system location comprises a transaction system logical network address such as an IP address, the system may determine whether the increased authorization level is required for the transaction by determining whether the transaction system's logical address is an authorized transaction system logical network address associated with the account.

Once the increased authorization criterion or criteria are selected for the increased authorization, at step 240 the system may prepare and send an increased authorization inquiry to the transaction system, soliciting user response corresponding to the criterion or criteria. Thus, the increased authorization inquiry may be associated with a predetermined response. For example, if the system selects a password as the increased authorization criterion, then the increased authorization inquiry may be a prompt for the user to input a password at the transaction system, and the issuer system already knows the expected response because it may be a user-selected password. As another example, if the increased authorization criteria are security questions, the increased authorization inquiry may comprise the security question, and the issuer system may know the expected or predetermined answers to such questions, which were provided by the account holder in setting up his or her account.

Continuing with the example above wherein the increased authorization criterion is a password, and if the transaction system is a typical POS device with a card reader, the transaction system may prompt the user in response to receiving the increased authorization inquiry to input the password via a keypad on the card reader, for example. The transaction system may then relay the response back to the issuer system, where upon the issuer system may receive the user response at step 245 and determine whether to authorize the transaction based on the response by the user and the predetermined response associated with the increased authorization inquiry. In some embodiments, at step 250, the issuer system may determine whether the predetermined response associated with the increased authorization inquiry matches the user input response to the authorization inquiry.

In response to determining that the user input response matches the predetermined response at step 256 the issuer system may authorize the transaction and transmit an authorization to the merchant at step 270. If the issuer system determines that the response does not match the predetermined response at step at step 255 the issuer system denies the transaction and transmits an authorization denied message to the transaction system at step 260. Some embodiments herein may implement some or all of these steps, and not necessarily in the order herein described.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
receiving, at an issuer system, a transaction authorization request for a transaction between a user and a transaction system, wherein the transaction authorization request comprises transaction system data and account data associated with an account;
determining a transaction system location based on the transaction system data;
receiving, from an account holder device associated with the account, an account holder device location;
determining whether an increased authorization level is required for the transaction based on the transaction system location and the account holder device location;
in response to determining the increased authorization level is required for the transaction, transmitting an increased authorization inquiry to the transaction system, wherein the increased authorization inquiry is associated with a predetermined response;
receiving, from the transaction system, a response by the user to the increased authorization inquiry; and
determining, at the issuer system, whether to authorize the transaction based on the response by the user and the predetermined response.

2. The method of claim 1, wherein determining the transaction system location based on the transaction system data comprises:
identifying, from the transaction system data, transaction system identification information;
querying a location database with the transaction system identification information; and
obtaining the transaction system location from the transaction system location database.

3. The method of claim 1, wherein determining whether the increased authorization level is required for the transaction comprises determining whether a proximity threshold is satisfied based on a comparison of the transaction system location and the account holder device location.

4. The method of claim 1, wherein the increased authorization inquiry is associated with an increased authorization criterion, and further comprising:
selecting the increased authorization criterion from a plurality of increased authorization criteria.

5. The method of claim 1, wherein the response by the user to the increased authorization inquiry comprises a personal identification number associated with the account.

6. The method of claim 1, further comprising:
in response to determining that the response by the user matches the predetermined response, authorizing the transaction; and
transmitting an authorization message for the transaction to the transaction system.

7. The method of claim 1, further comprising:
in response to determining that the response by the user does not match the predetermined response, denying the transaction; and
transmitting an authorization denied message for the transaction to the transaction system.

8. The method of claim 1, wherein the account holder device comprises an application with application program interface access to the issuer system, and further comprising:
requesting, from the application, the account holder device location.

9. The method of claim 8, wherein the response by the user to the increased authorization inquiry comprises a one-time password associated with the account holder device.

10. The method of claim 1, wherein the transaction system location comprises a transaction system logical network address, and wherein determining whether an increased authorization level is required for the transaction comprises:
determining whether the transaction system logical network address is an authorized transaction system logical network address associated with the account.

11. A computer configured to access a storage device, the computer comprising:
a processor; and
a non-transitory, computer-readable storage medium storing computer-readable instructions that when executed by the processor cause the computer to perform:
receiving, at an issuer system, a transaction authorization request for a transaction between a user and a transaction system, wherein the transaction authorization request comprises transaction system data and account data associated with an account;
determining a transaction system location based on the transaction system data;
receiving, from an account holder device associated with the account, an account holder device location;
determining whether an increased authorization level is required for the transaction based on the transaction system location and the account holder device location;
in response to determining the increased authorization level is required for the transaction, transmitting an increased authorization inquiry to the transaction system, wherein the increased authorization inquiry is associated with a predetermined response;
receiving, from the transaction system, a response by the user to the increased authorization inquiry; and
determining, at the issuer system, whether to authorize the transaction based on the response by the user and the predetermined response.

12. The computer of clam 11, wherein determining the transaction system location based on the transaction system data comprises:
identifying, from the transaction system data, transaction system identification information;
querying a location database with the transaction system identification information; and
obtaining the transaction system location from the transaction system location database.

13. The computer of clam 11, wherein determining whether the increased authorization level is required for the transaction comprises determining whether a proximity threshold is satisfied based on a comparison of the transaction system location and the account holder device location.

14. The computer of clam 11, wherein the increased authorization inquiry is associated with an increased authorization criterion, and further comprising:
selecting the increased authorization criterion from a plurality of increased authorization criteria.

15. The computer of clam 11, further comprising:
in response to determining that the response by the user does not match the predetermined response, denying the transaction; and
transmitting an authorization denied message for the transaction to the transaction system.

16. The computer of clam 11, wherein the account holder device comprises an application with application program interface access to the issuer system, and further comprising:
requesting, from the application, the account holder device location.

17. The computer of claim 16, further comprising:
in response to determining the increased authorization level is required for the transaction, determining a one-time password associated with the transaction; and
sharing the one-time password with the account holder device.

18. The computer of clam 17, wherein the response by the user to the increased authorization inquiry comprises receiving, from a near-field communication reader associated with the transaction system, the one-time password associated with the transaction.

19. The computer of clam 11, wherein the transaction system location comprises a transaction system logical network address, and wherein determining whether an increased authorization level is required for the transaction comprises:
determining whether the transaction system logical network address is an authorized transaction system logical network address associated with the account.

20. A computer program product comprising:
a computer-readable storage medium having computer-readable program code embodied therewith, the computer-readable program code comprising:
computer-readable program code configured to receive, at an issuer system, a transaction authorization request for a transaction between a user and a transaction system, wherein the transaction authorization request comprises transaction system data and account data associated with an account;
computer-readable program code configured to determine a transaction system location based on the transaction system data, wherein determining the transaction system location based on the transaction system data comprises:
identifying, from the transaction system data, transaction system identification information;
querying a location database with the transaction system identification information; and
obtaining the transaction system location from the transaction system location database;
computer-readable program code configured to receive, from an account holder device associated with the account, an account holder device location;
computer-readable program code configured to determine whether an increased authorization level is required for the transaction based on the transaction system location and the account holder device location;
computer-readable program code configured to determine the increased authorization level is required for the transaction and transmit an increased authorization inquiry to the transaction system, wherein the increased authorization inquiry is associated with a predetermined response;
computer-readable program code configured to receive, from the transaction system, a response by the user to the increased authorization inquiry; and
computer-readable program code configured to determine, at the issuer system, whether to authorize the transaction based on the response by the user and the predetermined response.
